(19) United States
(12) Patent Application Publication
(10) Pub. No.: US 2026/0280285 A1
(43) Pub. Date: Sep. 17, 2026

(54) CONTROLLING THE DAMPING OF SIDEWARDS TOWER OSCILLATIONS BASED ON A POWER OSCILLATION DISTURBANCE LEVEL

(71) Applicant: VESTAS WIND SYSTEMS A/S, Aarhus N (DK)

(72) Inventors: Karthik Krishnan JAMUNA, Trivandrum (IN); Mads Rajczyk SKJELMOSE, Risskov (DK); Mu WEI, Solbjerg (DK); Naga Srinivas KAMARAJUGADDA, Visakhapatnam (IN); Torsten LUND, Fredericia (DK); Torben ROKKEDAL, Ebeltoft (DK); Rishi SUMAN, Aarhus N (DK)

(21) Appl. No.: 19/168,403

(22) PCT Filed: Mar. 22, 2024
(86) PCT No.: PCT/DK2024/050059

§ 371 Date: Sep. 24, 2025

(30) Foreign Application Priority Data
Mar. 24, 2023 (DK) PA202370150

(51) Int. Cl. H02J 3/0014; H02J 3/38; H02J 3/46; H02J 101/28

(52) U.S. Cl. CPC H02J 3/00142; H02J 3/381; H02J 3/46; H02J 2101/28

(57) ABSTRACT

The present invention relates to control of wind turbines of a wind park in relation to damping sidewards tower oscillations in view of a power oscillation disturbance level at the point of measurement of an electrical grid. The invention comprising determining a power oscillation disturbance level of at the point of measurement of the electrical grid; determining a grid condition level at the point of measurement; and determining a disturbance severity based on the power oscillation disturbance level and the grid condition level. Upon receiving a request to reduce the power oscillation disturbance level at the point of measurement from a system operator, the group of wind turbines is operated to reduce the power oscillation disturbance level based on the disturbance severity.

### FIELD OF THE INVENTION

The present invention relates to control of a group of wind turbines of a wind park, and in particular it relates to controlling the damping of sidewards tower oscillations of a group of wind turbines of a wind park to reduce the power oscillation disturbance level at the point of measurement of an electrical grid.

### BACKGROUND OF THE INVENTION

Modern wind turbines are controlled and regulated continuously with the purpose of ensuring optimal power extraction from the wind under the current wind, and weather, while at the same time ensuring that the loads on the different components of the wind turbine are at any time kept within acceptable limits, and while respecting externally set operational constraints.

During operation the wind turbine may experience oscillations of specific components, such as tower oscillations. Tower oscillations, and in particular sidewards tower oscillations, may be mitigated by imposing a modulated power signal to the power reference, e.g. the power reference signal may be modulated in antiphase with the tower oscillations, leading to a damping of the sidewards tower movement.

The damping of the tower oscillations is done to reduce the resulting fatigue exposure of the tower, however the addition of the power modulation signal may risk adding power oscillations to the electrical grid, and risk violating requirements set by the grid operator.

In this regard requirements may be set for wind parks to keep power oscillations at the point of common coupling (PCC) below a certain level. Such requirements may sometimes lead to conflicts with the urge of an individual wind turbine controller to modulate the wind turbine power output to counteract mechanical oscillations.

Solutions are suggested in e.g. U.S. Pat. No. 10,907,613 and WO2022253396. Strategies are proposed to selectively enable or disable some damping control signals for wind turbines in the wind park to avoid the sum of the selected damping control signals exceeding a predetermined threshold.

Nevertheless, there is still a need to find solutions which target appropriate control strategies to handle the conflicting aspects of damping wind turbine sidewards oscillations and keeping grid oscillations within acceptable limits. It is against this background to which the present invention is set.

### SUMMARY OF THE INVENTION

In a first aspect, there is provided a method of damping sidewards tower oscillations of a group of wind turbines of a wind park commonly supplying electric energy to an electrical grid, each wind turbine comprises a damping controller for determining a damping control signal for counteracting a sidewards tower oscillation, the method comprising:
determining a power oscillation disturbance level of at a point of measurement of the electrical grid;
determining a grid condition level at the point of measurement of the electrical grid;
determining a disturbance severity based on the power oscillation disturbance level and the grid condition level;
upon receiving a request to reduce the power oscillation disturbance level at the point of measurement of the electrical grid from a system operator, operate the group of wind turbines of the wind park to reduce the power oscillation disturbance level based on the disturbance severity.

The state of a typical electrical grid is a complicated and varying state depending on the states of the electricity providers coupled to the electrical grid and the electricity consumers coupled to the electrical grid, in connection with various electrical components coupled to the grid, e.g. for grid stability purposes. Sometimes an electrical grid can absorb larger power oscillations than at other times, depending on the circumstances. For a robust electrical grid, there is a benefit in accepting larger power oscillations from tower damping, since the fatigue exposure can be kept down by this, whereas for a weak grid, at least temporarily there can be a need for allowing larger fatigue exposure to ensure grid stability.

To address this issue, the power oscillation disturbance level is reduced only if requested by the grid operator. The wind turbine controller has access to the grid condition at a point of coupling of the wind park to the electrical grid, e.g. at the point of measurement of the electrical grid, but normally not to the grid conditions at the larger electrical grid. If the electrical grid on a larger scale can withstand the power oscillations seen at the point of measurement, there is no benefit in restricting tower oscillations, contrary it is advantageous to condition reduction of the power oscillation disturbance level at the point of measurement upon receiving a request from a system operator.

Here reference is made to the point of measurement of the electrical grid, typical this point of measurement is the point of common coupling PCC, but other points of measurement of the electrical grid can be selected for a given situation.

Upon receipt of the request to reduce the power oscillation disturbance level from the system operator, it is beneficial to operate the group of wind turbines of the wind park to reduce the power oscillation disturbance level based on the disturbance severity. The disturbance severity being based on the power oscillation disturbance level and the grid condition at a point of measurement of the electrical grid. The disturbance severity can be influenced by modifying the control of the wind turbines of the wind park. By taking the grid condition at the point of measurement of the electrical grid into account when modifying the control of the wind turbines, a balanced compromise between reducing the power oscillation disturbance level and modifying the tower damping can be set, since a robust grid condition support a mild approach to reducing the power oscillation disturbance level whereas a weak grid condition requires a more aggressive approach to reducing the power oscillation disturbance level.

In an embodiment, determining the power oscillation disturbance level comprises comparing the power oscillation disturbance level to one or more thresholds. Each threshold may indicate a preselected disturbance level among a list of disturbance levels and associated thresholds, such as a first threshold being assigned to a low disturbance level, a second threshold being assigned to a medium disturbance level and a third threshold being assigned to a high disturbance level. Each disturbance level may e.g. be a weight assigned to the disturbance level for use in determining the severity level.

In an embodiment, the grid condition is determined based on a grid inertia of the electrical grid or on a ROCOF of the electrical grid. Both ROCOF and Inertia will reflect the grid weakness. The higher ROCOF is, the weaker a grid is, while, the lower inertia is, the weaker a grid is.

Grid inertia and ROCOF are standard measures of the robustness of an electrical grid.

In an embodiment, determining the grid condition comprises determining the power oscillation disturbance frequency of the electrical grid at the point of measurement and/or a power oscillation disturbance amplitude of the electrical grid at the point of measurement. The disturbance frequency and/or disturbance amplitude can be determined from frequency analysis of the power signal at the point of measurement. Such power signal can be obtained from a power meter connected to the point of measurement.

The power oscillation disturbance frequency may be compared to a list of defined problematic frequencies and assigned a weight based on a proximity with a problematic frequency. The list of defined problematic frequencies may e.g. be dynamically updated by the system operator, e.g. based on frequencies of the larger electrical grid. Electrical disturbances may be better tolerated at certain frequencies that at other frequencies. Thus a larger amplitude of the electrical disturbance may be tolerated for frequencies not on the list of defined problematic frequencies than for frequencies on the list of defined problematic frequencies.

In an embodiment, the disturbance severity is determined by multiplying the disturbance level with the grid condition level.

In embodiments, a disturbance severity level is determined according to a defined list of levels, e.g. first low level, second medium level, third high level, fourth very high level, etc.

In an embodiment, for a first lowest level of disturbance severity the group of wind turbines are operated to reduce the power oscillation disturbance level by instructing the damping controller of each selected wind turbine of the group of the wind turbines to restrict the damping control signal. With a low severity it may be sufficient to merely restrict the damping level. In this manner tower damping is still performed, but at a lower level.

In an embodiment, the level of restricting the damping control signal for each selected wind turbine of the group of wind turbines is based on a frequency difference between the power oscillation disturbance of the electrical grid at the point of measurement and the damping control signal for the selected wind turbine and/or a phase angle difference between the power oscillation disturbance signal of the electrical grid at the point of measurement and the active power oscillation from the selected wind turbine. In this manner wind turbines which are damped with a damping control signal being close in frequency or in phase with the power oscillation disturbance signal is restricted harder thereby reducing the frequency content selectively. In this manner, wind turbines which does not directly contribute to the power oscillation disturbance frequency of the electrical grid are not restricted.

In an embodiment, the level of restricting the damping control signal for each selected wind turbine of the group of wind turbines is based on an amplitude level of the damping control signal for the selected wind turbine. This is a simple and direct manner of controlling the damping control signal.

In an embodiment, the level of restricting the damping control signal for each selected wind turbine of the group of wind turbines is based on an accumulated fatigue load of the tower of the selected wind turbine and/or is based on a remaining lifetime of the tower of the selected wind turbine. The wind turbine controller, or connected computing unit, may keep a repository of accumulated fatigue load, e.g. by keeping a rain flow count based on tower vibrations or may keep an updated determination of remaining lifetime of the tower. In this way turbines with a high accumulated fatigue level or a low remaining lifetime may be allowed to perform tower damping at a higher level than turbines with a low accumulated fatigue level or a high remaining lifetime.

In an embodiment, for a second level of disturbance severity, higher than the first level, the plurality of wind turbines may be operated to reduce the power oscillation disturbance level by instructing the damping controller of each selected wind turbine of the group of the wind turbines to disable the damping control signal. Disabling the damping control signal will effectively stop the turbine from injecting a power disturbance into the electrical grid.

In an embodiment, the damping controller of the selected wind turbine being instructed to disable the damping control signal is conditioned by a counter of earlier disabling of the damping control signal is below a preset disabling limit number. A wind turbine is designed to withstand a certain fatigue level. Disabling the damping control signal will cause a higher fatigue exposure than not disabling the damping control signal, as the turbine tower oscillations are not actively damped. Therefore, such disablement may only be tolerated for a defined number of times.

In embodiments, the determination of whether or not disabling the damping control signal can be made in different ways.

In an embodiment, determining whether or not disabling the damping control signal of each selected wind turbine of the group of wind turbines is based on a frequency difference between the power oscillation disturbance of the electrical grid at the point of measurement and the damping control signal for the selected wind turbine and/or a phase angle difference between the power oscillation disturbance signal of the electrical grid at the point of measurement and the damping control signal for the selected wind turbine.

In an embodiment, determining whether or not disabling the damping control signal of each selected wind turbine of the group of wind turbines is based on an amplitude level of the damping control signal for the selected wind turbine.

In an embodiment, determining whether or not disabling the damping control signal of each selected wind turbine of the group of wind turbines is based on an accumulated fatigue load of the tower of the selected wind turbine and/or is based on a remaining lifetime of the tower of the selected wind turbine.

In an embodiment, for a third level of disturbance severity, higher than the first and second level, the plurality of wind turbines are operated to reduce the power oscillation disturbance level by instructing a wind turbine controller of each selected wind turbine of the group of the wind turbines to shut down the wind turbine.

If disabling the damping control signal of some or all wind turbines connected to the measurement point at the electrical grid is not enough to reduce the power oscillation disturbance level to a required level, the disturbance is likely not originating from the damping control signal, and each selected wind turbine of the group of the wind turbines is instructed to shut down the wind turbine.

In embodiments, the determination of whether or not shutting down a wind turbine can be made in different ways.

In an embodiment, determining whether or not shutting down the selected wind turbine of the group of wind turbines is based on a frequency difference between the power oscillation disturbance of the electrical grid at the point of measurement and the damping control signal for the selected wind turbine and/or a phase angle difference between the power oscillation disturbance signal of the electrical grid at the point of measurement and the damping control signal for the selected wind turbine.

In an embodiment, determining whether or not shutting down the selected wind turbine of the group of wind turbines is based on an amplitude level of the damping control signal for the selected wind turbine.

In an embodiment, determining whether or not shutting down the selected wind turbine of the group of wind turbines is based on an accumulated fatigue load of the tower of the selected wind turbine and/or is based on a remaining lifetime of the tower of the selected wind turbine.

In an embodiment, for a forth (even higher) level of disturbance severity, the plurality of wind turbines are operated to reduce the power oscillation disturbance level by instructing all wind turbines of the wind park to shut down. Shutting down all wind turbines of the wind park is normally only needed if the electrical grid is unstable to such an extend that the electrical grid risk closing down.

In a further aspect is provided a control system for controlling at least one wind turbine of a group of wind turbines of a wind park commonly supplying electric energy to an electrical grid, each wind turbine comprises a damping controller for determining a damping control signal for counteracting a sidewards tower oscillation, the control system comprising a processing unit being arranged to:
determining a power oscillation disturbance level of at a point of measurement of the electrical grid;
determining a grid condition level at the point of measurement of the electrical grid;
determining a disturbance severity based on the power oscillation disturbance level and the grid condition level;
upon receiving a request to reduce the power oscillation disturbance level at the point of measurement of the electrical grid from a system operator, operate the group of wind turbines of the wind park to reduce the power oscillation disturbance level based on the disturbance severity.

The control system may be a distributed control system comprising a central controller connected to the controllers of the wind turbines of the wind park.

Aspects or elements, and in particular the method of the first aspect may be implemented on a computer program product provided on a computer readable storage medium or being downloadable from a communication network. The computer program product comprises instructions to cause a data processing system, e.g. in the form of a controller, to carry out the instruction when loaded onto the data processing system.

In general, a controller may be a unit or collection of functional units which comprises one or more processors, input/output interface(s) and a memory capable of storing instructions can be executed by a processor.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates, in a schematic view, an example of a wind turbine;

FIG. 2 illustrates, in a schematic view, an example of a group of wind turbines of a wind park commonly supplying electric energy to an electrical grid;

FIG. 3 illustrates a schematic flow diagram implemented into a power plant controller (PPC) and

FIG. 4 illustrates a diagram of a schematic communication structure between the power plant controller (PPC) and each of the wind turbine controllers.

### DESCRIPTION OF EMBODIMENTS

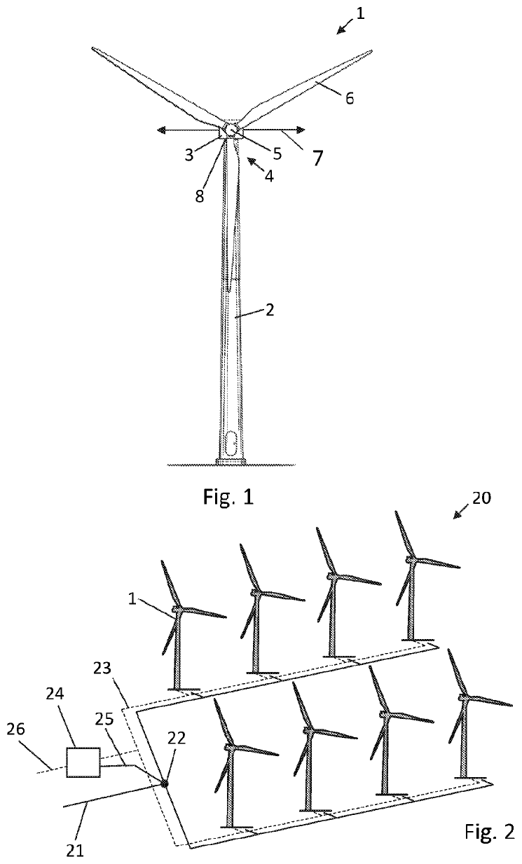

FIG. 1 illustrates, in a schematic view, an example of a wind turbine 1. The wind turbine 1 includes a tower 2, a nacelle 3 disposed at the apex of the tower, and a rotor 4 operatively coupled to a generator housed inside the nacelle 3. In addition to the generator, the nacelle houses miscellaneous components required for converting wind energy into electrical energy and various components needed to operate, control, and optimize the performance of the wind turbine 1. The rotor 4 of wind turbine includes a central hub 5 and a plurality of blades 6 that project outwardly from the central hub 5. In the illustrated embodiment, the rotor 4 includes three blades 6, but the number may vary. Moreover, the wind turbine comprises a control system. The control system may be placed inside the nacelle or distributed at a number of locations inside (or externally to) the turbine and communicatively connected. The rotor blades are pitch-adjustable. The rotor blades can be adjusted in accordance with a collective pitch setting, where each of the blades are set to the same pitch value. In addition to that, the rotor blades are adjustable in accordance with individual pitch settings, where each blade may be provided with an individual pitch setting.

The turbine may oscillate in the sidewards direction 7, that is in a direction of the rotor plane. Such vibration is also sometimes referred to as lateral oscillations or side-side oscillations.

In a general embodiment of the present invention oscillatory movement is reduced by imposing a damping control signal for counteracting a sidewards tower oscillations, the damping control signal being a power offset signal in anti-phase with tower top sidewards velocity. In embodiments, the power offset signal to dampen the sidewards oscillations may be determined in a different manner than based on tower velocity.

FIG. 2 illustrates, in a schematic view, an example of a group 20 of wind turbines of a wind park commonly supplying electric energy to an electrical grid 21.

The wind turbines are connected together in a wind park electrical grid, which at a point 22 of measurement of the electrical grid (typically a point of common coupling PCC, 22) is connected to an electrical grid, such as a large-scale electrical grid 21.

FIG. 2 further illustrates a communication network 23 which is connected to the control system of each wind turbine and to a power plant controller PPC 24, also sometimes referred to as a wind park controller or a wind farm controller. The PPC is further connected 25 to a sensor, such as a power meter, connected to the point of common coupling 22 for detecting the power signal at the point of common coupling. The PPC being programmed to based on analysis of the power signal to send instruction to the individual controllers of the wind turbines through the communication network. The PPC may via network connection 26 to a broader network, e.g. the internet, receive instructions and/or information from the system operator of the electrical grid 21.

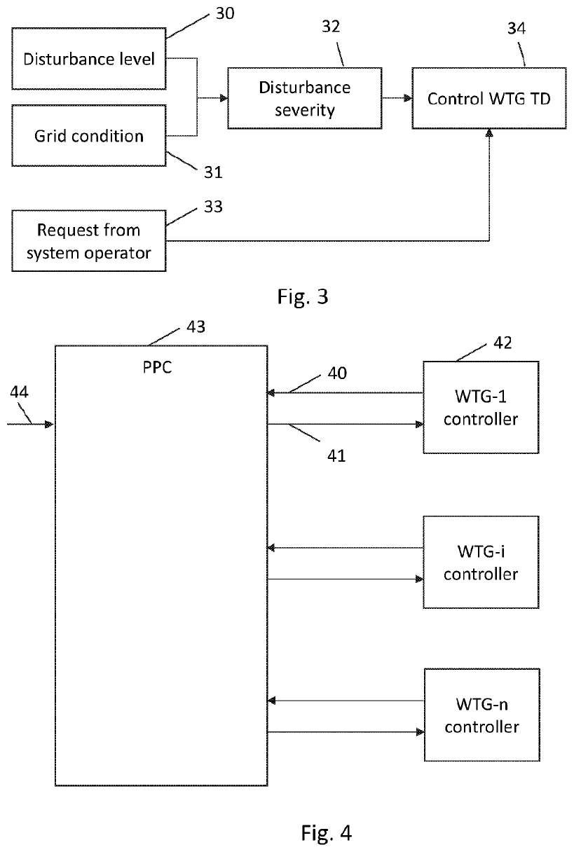

FIG. 3 illustrates a schematic flow diagram implemented into the PPC to trigger that the wind turbines of the group of wind turbines are operated to reduce the power oscillation disturbance level at the point of common coupling.

A power oscillation disturbance level 30 of at a point of measurement of the electrical grid is determined. And a grid condition 31 at the point of measurement of the electrical grid is determined. Based on these two elements, a disturbance severity 32 is determined. Upon receiving a request 33 to reduce the power oscillation disturbance level at the point of measurement of the electrical grid from a system operator, the group of wind turbines of the wind park are controlled 34 to reduce the power oscillation disturbance level based on the disturbance severity. The control of the group of wind turbines is typically done by sending individual control commands to all or selected wind turbines.

FIG. 4 illustrates a diagram of a schematic communication structure between the power plant controller (PPC) 43 and each of the wind turbine controllers (WTG-1, WTG-I, WTG-n) 42 for n wind turbines of the wind park. The communication structure is implemented to support communication from a wind turbine controller to the PPC, and vice versa 40, 41. The PPC is further arranged to receive inputs 44, e.g. communication from the system operator, sensor input from connected sensors (e.g. power meter) as well as further input, such as input from a connected SCADA system.

Embodiments of the invention is now further described with reference to FIGS. 3 and 4.

A power oscillation disturbance level is determined at a point of measurement. The point of measurement is in the following exemplified by the point of common coupling PCC.

In an embodiment, the power oscillation disturbance level 30 is a peak-to-peak level of the power oscillations measured at the PCC. The peak-to-peak level may be set as a percentage of the actual produced active power at the PCC. In an embodiment, the power oscillation disturbance level comprises comparing the power oscillation disturbance level to one or more thresholds. The thresholds may be the peak-to-peak level percentage of the actual produced active power at the PCC. In an embodiment, a low power oscillation disturbance level may be set for a first peak-to-peak level percentage of the actual produced active power, such as below 0.5%. A medium power oscillation disturbance level may be set for a second peak-to-peak level percentage of the actual produced active power, such as between 0.5% and 1.0%. A high power oscillation disturbance level may be set for a third peak-to-peak level percentage of the actual produced active power, such as above 1.0%. The power oscillation disturbance level may be set as a weight, e.g. as 1, 2 and 3 for the three example levels: low, medium and high.

In an embodiment, determining the grid condition 31 comprises determining a grid inertia of the electrical grid or determining a ROCOF of the electrical grid. The grid condition may, e.g. be set as low, medium or high, with low referring to a robust grid at the point of measurement, and high to a weak grid at the point of measurement.

The grid inertia is typically determined by the system operator as an estimate of the available inertia in the larger grid. This may be provided as an input 44 to the PPC.

The ROCOF, being a standard measure of a Rate Of Change Of Frequency being the time derivative of the power system frequency (df/dt). The ROCOF being determined by the PPC based on the power meter measurements. The ROCOF may be set as a weight, e.g. as 1, 2 and 3 for the three example levels: low, medium and high, determined based on that ROCOF being 1 (high) in the range of (x1, y1), 2 (medium) in the range of (x2, y2), x2 and y2 being higher than x2 and y2, and 3 (low) in the range of (x3, y3), x3 and y3 being higher than x3 and y3.

In embodiments, the determining the grid condition comprises determining power oscillation disturbance frequency of the electrical grid and/or a power oscillation disturbance amplitude of the electrical grid. In such an embodiment, the disturbance level is used to influence the grid condition, e.g. by downgrading the grid condition for low power oscillation disturbance amplitude or for power oscillation disturbance frequency being in selected frequency ranges which are not considered problematic.

In an embodiment the disturbance severity 32 is determined by combining the disturbance level and the grid condition level to determine a common level. By combining these two levels to a common level, it can be handled that a high disturbance level can be tolerated for a low grid condition, and vice versa. In an embodiment, the disturbance level may a multiplication of the two levels, which in the above example may provide a disturbance severity of 1, 2, 3, 4, 6 and 9. A low severity may be assigned to the result of 1, 2 or 3, a medium severity to the result of 4, a high severity to the result of 6, and a very high severity to the result of 9.

Upon receiving a request 33 to reduce the power oscillation disturbance level at the point of measurement of the electrical grid from a system operator, the group of wind turbines of the wind park are controlled 34 to reduce the power oscillation disturbance level based on the disturbance severity.

Different manners of reducing the power oscillation disturbance level can be achieved in dependency of the disturbance severity.

In an embodiment a mapping between the disturbance severity and the manner of control is set as follows:

| | |
|---|---|
| Low severity | → Restrict the damping control signal |
| Medium severity | → Disable the damping control signal |
| High severity | → Shutdown of selected wind turbines |
| Very high severity | → Shutdown of all wind turbines |

In an embodiment, a power modulation limit may be set to the damping signal. For example, a 10% limit of the power setpoint may be set to the modulation signal.

In a first lowest level of disturbance severity the group of wind turbines are operated to reduce the power oscillation disturbance level by instructing the damping controller of each selected wind turbine of the group of the wind turbines to restrict the damping control signal.

That is a limit of the damping signal may be sent 41 to the controller 42 of the wind turbines.

In an embodiment, each of the wind turbines of the wind park is instructed with the same limit. However, the level of restricting the damping control signal for each selected wind turbine of the group of wind turbines may advantageously be set individually to the wind turbines. In this case the wind turbines are sent individual instructions 41.

Restricting the damping control signal is a relative mild control action which prioritizes tower damping over grid disturbance. If the disturbance severity is higher, this control action may not be sufficient, and subsequent more restrictive measures may be taken.

For a second level of disturbance severity, the plurality of wind turbines are operated to reduce the power oscillation disturbance level by instructing the damping controller of each selected wind turbine of the group of the wind turbines to disable the damping control signal.

Disabling of the damping control signal will naturally incur a higher fatigue level to the wind turbine tower. This higher fatigue exposure may be tolerated to ensure a stable grid. However, to ensure that the fatigue exposure is not too high over prolonged operation, disabling the damping control signal may be conditioned by a counter of earlier disabling of the damping control signal is below a preset disabling limit number. The wind turbine controller may keep count of this count and sent 40 it to the PPC, or the PPC itself may keep track of the wind turbines in the wind park.

For a third level of disturbance severity, the plurality of wind turbines are operated to reduce the power oscillation disturbance level by instructing a wind turbine controller of each selected wind turbine of the group of the wind turbines to shut down the wind turbine.

For a fourth level of disturbance severity the plurality of wind turbines are operated to reduce the power oscillation disturbance level by instructing all wind turbines of the wind park to shut down.

The selection of which turbines that are to be controlled with respect to restricting or disabling the damping control signal, and which turbines that should be should down, depending on the disturbance severity can be based on similar principles.

Depending on the severity, the turbines to control may be based on a frequency difference between the power oscillation disturbance of the electrical grid and the damping control signal for the selected wind turbine and/or a phase angle difference between the power oscillation disturbance signal of the electrical grid and the damping control signal for the selected wind turbine.

The selection of which turbines to control may be based on an amplitude level of the damping control signal. That is only turbines with an amplitude level above a given preset level may be controlled.

In an embodiment, may the accumulated fatigue load of the tower of the selected wind turbine and/or an estimated remaining lifetime of the tower of the selected wind turbine be used for the determination.

Example embodiments of the invention have been described for the purposes of illustration only, and not to limit the scope of the invention as defined in the accompanying claims.

1. A method of controlling at least one wind turbine of a group of wind turbines of a wind park commonly supplying electric energy to an electrical grid, each wind turbine comprises a damping controller for determining a damping control signal for counteracting a sidewards tower oscillation, the method comprising:
determining a power oscillation disturbance level of at a point of measurement of the electrical grid;
determining a grid condition level at the point of measurement of the electrical grid;
determining a disturbance severity based on the power oscillation disturbance level and the grid condition level;
upon receiving a request to reduce the power oscillation disturbance level at the point of measurement of the electrical grid from a system operator, operate the group of wind turbines of the wind park to reduce the power oscillation disturbance level based on the disturbance severity.

2. The method according to claim 1, wherein determining the power oscillation disturbance level comprises comparing the power oscillation disturbance level to one or more thresholds.

3. The method according to claim 1, wherein the determining the grid condition level comprises determining a grid inertia of the electrical grid or determining a ROCOF of the electrical grid.

4. The method according to claim 1, wherein the determining the grid condition comprises determining power oscillation disturbance frequency of the electrical grid and/or a power oscillation disturbance amplitude of the electrical grid.

5. The method according to claim 1, wherein the determining the disturbance severity comprises multiplying the disturbance level with the grid condition level.

6. The method according to claim 1, wherein for a first lowest level of disturbance severity the group of wind turbines are operated to reduce the power oscillation disturbance level by instructing the damping controller of each selected wind turbine of the group of the wind turbines to restrict the damping control signal.

7. The method according to claim 6, wherein the level of restricting the damping control signal for each selected wind turbine of the group of wind turbines is based on a frequency difference between the power oscillation disturbance of the electrical grid at the point of measurement and the damping control signal for the selected wind turbine and/or a phase angle difference between the power oscillation disturbance signal of the electrical grid at the point of measurement and the damping control signal for the selected wind turbine.

8. The method according to claim 6, wherein the level of restricting the damping control signal for each selected wind turbine of the group of wind turbines is based on an amplitude level of the damping control signal for the selected wind turbine.

9. The method according to claim 6, wherein the level of restricting the damping control signal for each selected wind turbine of the group of wind turbines is based on an accumulated fatigue load of the tower of the selected wind turbine and/or is based on a remaining lifetime of the tower of the selected wind turbine.

10. The method according to claim 1, wherein for a second level of disturbance severity the plurality of wind turbines are operated to reduce the power oscillation disturbance level by instructing the damping controller of each selected wind turbine of the group of the wind turbines to disable the damping control signal.

11. The method according to claim 10, wherein instructing the damping controller of the selected wind turbine to disable the damping control signal is conditioned by a counter of earlier disabling of the damping control signal is below a preset disabling limit number.

12. The method according to claim 10, wherein determining whether or not disabling the damping control signal of each selected wind turbine of the group of wind turbines is based on a frequency difference between the power oscillation disturbance of the electrical grid at the point of measurement and the damping control signal for the selected wind turbine and/or a phase angle difference between the power oscillation disturbance signal of the electrical grid at the point of measurement and the damping control signal for the selected wind turbine.

13. The method according to claim 10, wherein determining whether or not disabling the damping control signal of each selected wind turbine of the group of wind turbines is based on an amplitude level of the damping control signal for the selected wind turbine.

14. The method according to claim 10, wherein determining whether or not disabling the damping control signal of each selected wind turbine of the group of wind turbines is based on an accumulated fatigue load of the tower of the selected wind turbine and/or is based on a remaining lifetime of the tower of the selected wind turbine.

15. The method according to claim 1, wherein for a third level of disturbance severity the plurality of wind turbines are operated to reduce the power oscillation disturbance level by instructing a wind turbine controller of each selected wind turbine of the group of the wind turbines to shut down the wind turbine.

16. The method according to claim 15, wherein determining whether or not shutting down the selected wind turbine of the group of wind turbines is based on a frequency difference between the power oscillation disturbance of the electrical grid at the point of measurement and the damping control signal for the selected wind turbine and/or a phase angle difference between the power oscillation disturbance signal of the electrical grid at the point of measurement and the damping control signal for the selected wind turbine.

17. The method according to claim 15, wherein determining whether or not shutting down the selected wind turbine of the group of wind turbines is based on an amplitude level of the damping control signal for the selected wind turbine.

18. The method according to claim 15, wherein determining whether or not shutting down the selected wind turbine of the group of wind turbines is based on an accumulated fatigue load of the tower of the selected wind turbine and/or is based on a remaining lifetime of the tower of the selected wind turbine.

19. The method according to claim 1, wherein for a fourth level of disturbance severity the plurality of wind turbines are operated to reduce the power oscillation disturbance level by instructing all wind turbines of the wind park to shut down.

20. A control system for controlling at least one wind turbine of a group of wind turbines of a wind park commonly supplying electric energy to an electrical grid, each wind turbine comprises a damping controller for determining a damping control signal for counteracting a sidewards tower oscillation, the control system comprising a processing unit being arranged to perform an operation, comprising:
determining a power oscillation disturbance level of at a point of measurement of the electrical grid;
determining a grid condition level at the point of measurement of the electrical grid;
determining a disturbance severity based on the power oscillation disturbance level and the grid condition level;
upon receiving a request to reduce the power oscillation disturbance level at the point of measurement of the electrical grid from a system operator, operate the group of wind turbines of the wind park to reduce the power oscillation disturbance level based on the disturbance severity.
